(19) United States
(12) Patent Application Publication
(10) Pub. No.: US 2007/0292578 A1
(43) Pub. Date: Dec. 20, 2007

(54) Personal drink blender system with a single use ribbed interlocking drink container

(76) Inventor: Robert Joseph Baschnagel, Bayside, NY (US)

Correspondence Address: Robert Baschnagel III, 36-17 212 Street, Bayside, NY, 11361, US

(21) Appl. No.: 11/455,418

(22) Filed: Jun. 19, 2006

(51) Int. Cl. A01J 25/00

(52) U.S. Cl. 426/519

(57) ABSTRACT

A personal drink blender system with an interlocking ribbed disposable container for permitting a user to dispose of the cup and its constituent parts after a single use. The drink blender system with an interlocking ribbed disposable container includes a cup defining an interior for receiving the contents of the drink. The upper end of the cup has an opening into the interior. The exterior lower end of the cup is inverted and ribbed to allow for an interlocking with the wall of the blender base to hold the cup in place during mixing. A mixing apparatus integrally formed with the cup as a single unit. The mixing apparatus is mounted on the lower end of the cup and extends below and beyond the cup upward into the interior of the cup. The cup is formed of a plastic material and the 6-tooth driver mate is also made of a plastic material. The leading portion and the blade are made of a metal material, however the material does not detract from the cup's disposability. The driver assembly for driving the mixing apparatus by permitting the 6-tooth driver mate to be nested onto the driver assembly to cause the mixing apparatus to rotate on its axes.

### BACKGROUND OF THE INVENTION

1. Field of the Invention

The present invention relates to food blenders and more specifically relates to a new personal drink blender system with a single use interlocking ribbed drink container for providing the user with a safe and relatively low cost system that permits a user to dispose of the cup and its attendant mixing apparatus after a single use.

2. Description of the Prior Art

The use of food blenders is known in the prior art. More specifically, food blenders heretofore devised and utilized are known to consist basically of familiar, expected and obvious structural configurations, notwithstanding the myriad of designs encompassed by the crowded prior art which have been developed for the fulfillment of countless objectives and requirements. In addition to meeting the particular objectives and requirements, food blenders can be difficult to clean and thus making food blenders less than desirable to use.

U.S. Pat. No. 6,338,569 to McGill shows a food blending apparatus for blending products in a container where the container is made to be disposed of after the product in the container has been consumed and requires a complex sealing means to ensure that the food within the container does not leak out between the lid and the blender and the blender that extends through the lid and therefore increases the cost of the container. Also this apparatus is more apt for mixing, with the blending apparatus being comprised of entirely plastic components, which is not conducive to create the requisite vortex or pressure to pulverize coarser and otherwise more granular particles. Also plastic mixing apparatuses are prone to chipping when they come into contact with harder particles during blending, which can be hazardous to the health of the person utilizing the system. Additionally, the locking method used is both complicated and inefficient to properly lock the jar in and is likely to cause movement by the cup. U.S. Pat. No. 6,616,323 to McGill shows a food blending apparatus with a blender extending through a closure member of a container with the blender member being capable of being slid up and down in the container to blend the material in the container and allow disposal of the container after use while requiring a complex system for permitting a closure member to be inserted into the upper opening and sealing the upper opening while allowing a blender member to be coupled to closure member to allow the material in the container to be blended which adds complexity and additional cost. U.S. Pat. No. 6,854,875 to McGill shows a food blending apparatus for blending products that provides the materials in the container with the container to be disposed of after the material has been dispensed from the container as in U.S. Pat. No. 6,338,569 requires a complex sealing means to ensure that the food within the container does not leak out between the lid and the blender that extends through the lid and therefore increases the cost of the container as well as a plastic blade being an impracticable and potentially health-hazardous alternative to metal due to chipping and the like.

U.S. Pat. No. 6,071,006 to Hochstein shows a container for vending machines with a stirring shaft extending into the container from a cover. The stirring shaft extending into the container from a cover. The stirring shaft is rotated by a rotating device to mix the contents of the container with the cover being removed or pierced to gain access to the contents of the container, the process by which the container and stirring shaft are constructed increase the cost to produce the container. U.S. Pat. No. 1,519,798 to Pilkington shows a drink mixer that incorporates a stirrer in a glass to allow the contents of the glass to be mixed when the stirrer is rotated. The use of a glass container makes it cost prohibitive to dispose of the container after each use and therefore requires the user to clean the container after each use. U.S. Pat. No. 5,855,431 to Costanzo shows a rotating mixer and tray with a container with a whisk that extends through the base of the container and is coupled to a gear under the base of the container which rotates the whisk to stir the contents of the liquid when the gear is rotated by the motor in the motor housing unit, additionally, the container is intended to be reused and therefore requires the user to clean the container after every use.

U.S. Pat. No. 6,709,150 to Lin shows a juice blender having a container with a horizontal partition formed with a skirt and blades on a rotor positioned in the container for mixing the materials in the container. A coupler is positioned in the skirt of the container and engages a motor to turn the rotor and blades to mix the contents of the container. Additionally, the container is not intended to be discarded after every use and therefore requires the user to clean it after every use. U.S. Pat. No. 5,639,161 to Sirianni shows a pressured switch-controlled blender cup apparatus with a hollow base that houses a motor, power supply, and a variety of switches and a propeller coupled to the rotor of the motor extending through the bottom wall and into the cup and mixing materials in the cup when the cup is placed in the surface. The cup is not intended to be disposed of after each use and therefore requires cleaning of the cup and the propeller after each use. U.S. Patent Application No. 2005/11055205 to Baschnagel purports to show a drink blender system with a single use disposable drink container, however the use of plastic materials for the mixing apparatus is inefficient for creating a proper vortex and the requisite sharpness to fully pulverize coarser and more granular particles. U.S. Patent Application Attorney Docket No. R Basch 615 is for a disposable lid with the mixing apparatus, which is not integrally formed with or otherwise mountable on the cup itself.

In these respects, the drink blender system with a single use disposable lid according to the present invention substantially departs from the conventional concepts and designs of the prior art, and therefore provides an apparatus primarily developed for the purpose of permitting a user to dispose of the cup and the metal mixing apparatus after a single use.

### SUMMARY OF THE INVENTION

In view of the foregoing disadvantages inherent in the known types of food blenders now present in the prior art, the present inventions provides a new personal drink blender system with a single use disposable interlocking ribbed container construction wherein the same can be utilized for permitting a user to dispose of the cup and its attendant metal mixing apparatus after use.

To attain this, the present invention generally comprises a cup defining an interior for receiving the constituents of the drink. The cup has an upper end and a lower end. The upper end of the cup maintaining an opening into the interior. The lower end of the cup is substantially ribbed to provide the requisite support to withstand the torque of the blender base's power and to withstand the impact of any physical collisions between the cup and any particles maintained within the cup during blending. Furthermore the ribbed bottom portion is used to interlock itself with the wall of the blender base. The mixing apparatus extends upwardly from the lower end into the interior of the cup. A driver assembly drives the mixing apparatus to cause the apparatus to spin on a rotational axis thereby mixing the constituents of the drink.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One significant advantage of the present invention is the integration of the mixing apparatus with the substantially ribbed bottom portion of the cup to promote interlocking to the blender base to hold the cup snugly in place during blending as well as to provide additional support so that the cup does not disintegrate or otherwise become damaged when blending granular constituents.

Further advantages of the invention, along with the various features of novelty which characterize the invention, are pointed out with particularity in the claims annexed to and forming a part of this disclosure: For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings, wherein:

FIG. 1 is a perspective view of a new drink blender system with a single use disposable interlocking ribbed drink container according to the present invention.

FIG. 2 is a view of the bottom of the 6-tooth driver mate.

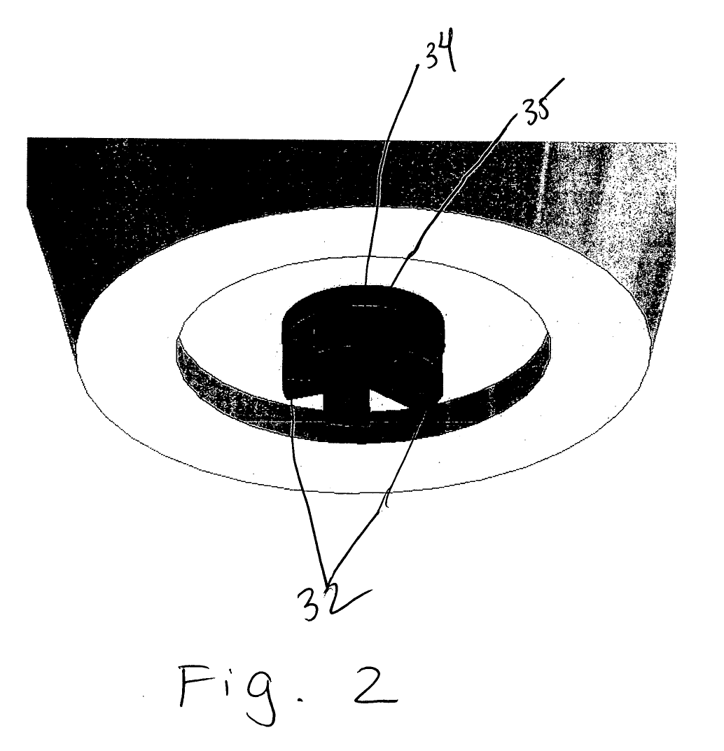

### DESCRIPTION OF PREFERRED EMBODIMENTS

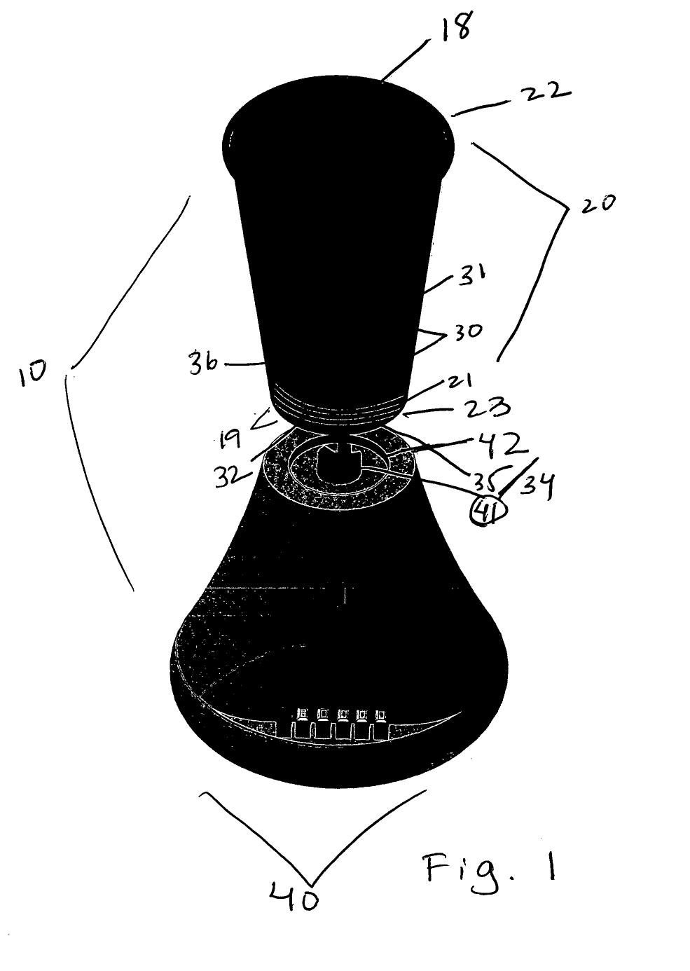

With reference now to the drawings, and in particular to FIG. 1 thereof, a new drink blender system with a single use disposable interlocking ribbed drink container embodying the principles and concepts of the present invention and generally designated by the reference numeral 10 will be described.

As best illustrated in FIG. 1, the drink blender system with a single use disposable interlocking ribbed drink container 10 generally comprises cup 20 preferably made of a rigid plastic such as mold injected polyproplylene, defining an interior 18 serving as an aperture to allow for the constituents to be blended in. The cup 20 has an upper end 22 and a lower end 23. The lower end 23 maintains a ribs 21 that are located on the recessed bottom 19 in order to allow the bottom portion and the lower end 23 of the cup 20 to lock in with the wall 42 of the blender base 40. The cup 20 further comprises a mixing apparatus 30, which consists of a metal blade 31 preferably made of a stainless steel material or something of the like in order to allow for optimal cutting and havey enough to create a proper vortex in or around the rotational axis. The blade 31 contains a lead portion 36 made of the same material as the blade, and leading down and meeting with the 6-tooth driver mate 32. The 6-tooth driver mate 32 is welded or otherwise attached to the lead portion 36. The 6-tooth driver mate 32 is made of a substantially rigid plastic such as mold injected polypropylene. The 6-tooth driver mate 32 maintains grooves 35 which essentially create the “6” teeth. These grooves 35 maintain an antagonistically designed metal support 34 which directly complements the 6-tooth design in order to absorb additional torque emanating from the blender base 40 and the driver shaft 41. The 6-tooth driver mate 32 nests with the driver shaft 41 of the blender base 40. The driver shaft 41 is designed in a complementary and antagonistic fashion to the 6-tooth driver mate 32 allowing for the driver shaft 41 to create a lock-and-key fit.

Accordingly, when the cup 20 is placed on the blender base 40, the driver shaft 41 is nested with the 6-tooth driver mate 32 via the grooves 35. The power from the driver shaft 41 causes the 6-tooth driver mate 32 to rotate in a circular motion, thereby sending the power to the lead portion 36 which causes the blade 31 to spin on a rotational axis.

With respect to the above description then, it is to be realized that the optimum dimensional relationships for the parts of the invention, to include variations in size, materials, shape, form, function and manner of operation, assembly and use, are deemed readily apparent to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for blending a drink using a single use personal disposable ribbed interlocking container, the system comprising:
a single use, disposable cup defining an interior for receiving constituents of the drink, the cup having an upper end and a lower end, the upper end of the cup having an opening into the interior, the lower end having a substantially ribbed texture that interlocks to the wall base of a blender system;
a metal mixing apparatus integrally formed as a single unit with the cup, the mixing apparatus being mounted on the driver assembly, the mixing apparatus located on driver assembly located at the lower end of the cup and extending upwardly into the interior of the cup, consisting of a driver mate extending from below and beyond the lower central portion of the cup and extending upwardly into the interior of the cup through a lead portion which ends at the metal blade; and
a plastic driver assembly for driving the mixing apparatus to mix the contents of the cup, the cup and mixing apparatus being removably mounted on a driver assembly.

2. The system as set forth in claim 1, wherein the cup comprises a bottom wall at the lower end of the cup, the bottom wall having a substantially flat lower surface for resting on a support but extending upward into a substantially ribbed surface for interlocking with the base wall of a corresponding blender base.

3. The system as set forth in claim 2, wherein the cup comprises a perimeter wall irremovably mounted on the bottom wall to form the interior of the cup.

4. The system as set forth in claim 2, wherein the cup is inverted at the bottom of the cup to further promote the locking of the cup with the blender base.

5. The system as set forth in claim 4, wherein the perimeter wall has a generally inverted frustaconical shape such that the diameter of the upper end of the cup is greater than a diameter in the lower end of the cup.

6. The system as set forth in claim 3 wherein the perimeter wall has a lower portion terminating at the bottom wall such that no portion of the perimeter wall extends beyond and below the bottom wall.

7. The system as set forth in claim 3, wherein the bottom wall and the perimeter wall are both formed of a durable plastic material, such that the cup may be crushed by the human hand.

8. The system as set forth in claim 1, wherein the driver assembly comprises a base having a resting surface on an upper location of the base.

6. The system as set forth in claim 4, wherein the 6-tooth driver mate is further supported by a metal support antagonistically shaped to the 6-tooth driver mate whereby allowing the metal support to fit snugly into the 6-tooth driver mate to absorb torque.

7. The system as set forth in claim 1, wherein the mixing apparatus comprises a pedestal driver mate irremovably mounted on the cup and extending into the interior of the cup, the pedestal driver mate having a bottom end positioned below and beyond the lower central portion of the cup and extending upward into a leading portion leading to and ending at the metal blade located in the interior of the cup;

8. The system as set forth in claim 7, wherein the driver mate contains a 6-tooth driver mate made of a durable plastic, that contains grooves in the material;

9. The system as set forth in claim 8, wherein the 6-tooth driver mate is supported antagonistically in the 6-tooth design by a metal support.

10. The system as set forth in claim 7, wherein the mixing apparatus is capable of being nested onto the driver assembly of the blender base via the 6-tooth driver mate whereby the mixing apparatus is powered and caused to rotate by said driver assembly.

11. The system as set forth in claim 1 wherein the driver assembly comprises a driver shaft extending upwardly from the upper location of the base, the driver shaft being rotatable, the driver shaft having a free upper end configured to engage the mixing apparatus when the cup is rested on the resting surface of the base.

12. The system as set forth in claim 11, wherein the driver assembly comprises a motor mounted on the base of the rotating driver shaft;

13. The system as set forth in claim 11, wherein the driver assembly comprises a guide wall extending upwardly from the base about the resting surface to create an interlocking space for the ribs of the cup and the shape of the cup so that the cup is held in position while the driver shaft engages the mixing apparatus.

14. The claim as set forth in claim 13, wherein the guide wall has an inner surface configured to allow the ribs on the outer surface of the cup to interlock to support the cup during mixing.
